(19) United States
(12) Patent Application Publication
(10) Pub. No.: US 2018/0189179 A1
(43) Pub. Date: Jul. 5, 2018

(54) DYNAMIC MEMORY BANKS

(71) Applicant: QUALCOMM Incorporated, San Diego, CA (US)

(72) Inventors: Yun Li, San Diego, CA (US); Jian Liang, San Diego, CA (US); Fei Xu, San Jose, CA (US); Zhen Chen, Saratoga, CA (US); Chun Yu, Rancho Santa Fe, CA (US); Tao Wang, Sunnyvale, CA (US)

(21) Appl. No.: 15/423,889

(22) Filed: Feb. 3, 2017

Related U.S. Application Data
(60) Provisional application No. 62/440,510, filed on Dec. 30, 2016.

(51) Int. Cl. G06F 12/0811; G06F 12/0875; G06F 12/0846

(52) U.S. Cl. CPC G06F 12/0811; G06F 12/0875; G06F 2212/283; G06F 2212/451; G06F 12/0846

(57) ABSTRACT

A cache memory may receive, from a client, a request for a long cache line of data. The cache memory may receive, from a memory, the requested long cache line of data. The cache memory may store the requested long cache line of data into a plurality of data stores across a plurality of memory banks as a plurality of short cache lines of data distributed across the plurality of data stores in the cache memory. The cache memory may also store a plurality of tags associated with the plurality of short cache lines of data into one of a plurality of tag stores in the plurality of memory banks.

This application claims the benefit of U.S. Provisional Patent Application 62/440,510, Dec. 30, 2016, the entire content of which is incorporated herein by reference.

### TECHNICAL FIELD

This disclosure generally relates to a computer system, and more specifically relates to a cache memory system.

### BACKGROUND

Cache memory systems in computer systems typically provide relatively smaller and lower latency memory. Such cache memory stores copies of a subset of data stored in main memory to reduce the average time for data access. To improve the performance of a cache memory system, the cache memory system may include a plurality of memory banks that may be accessed simultaneously by differing clients. For example, a first client may retrieve data stored in a first memory bank of the cache memory system, while a second client may retrieve data stored in a second memory bank of the cache memory system.

### SUMMARY

In one aspect, a method comprises receiving, by a cache memory from a client, a request for a long cache line of data. The method further comprises receiving, by the cache memory from a memory, the requested long cache line of data. The method further comprises storing, by the cache memory, the requested long cache line of data into a plurality of data stores across a plurality of memory banks as a plurality of short cache lines of data distributed across the plurality of data stores in the cache memory. The method further comprises storing, by the cache memory, a plurality of tags associated with the plurality of short cache lines of data into one of a plurality of tag stores in the plurality of memory banks.

In another aspect, an apparatus comprises a memory. The apparatus further comprises a cache memory operably coupled to the memory and configured to: receive, from a client, a request for a long cache line of data; receive, from the memory, the requested long cache line of data; store the requested long cache line of data into a plurality of data stores across a plurality of memory banks as a plurality of short cache lines of data distributed across the plurality of data stores in the cache memory; and store a plurality of tags associated with the plurality of short cache lines of data into one of a plurality of tag stores in the plurality of memory banks.

In another aspect, an apparatus comprises means for determining a first tag of the plurality of tags associated with the first short cache line based at least in part on a memory address of the long cache line of data. The apparatus further comprises means for determining a second tag of the plurality of tags associated with the second short cache line based at least in part on a memory address of the long cache line of data. The apparatus further comprises means for storing the first tag in a tag store of the plurality of tag stores. The apparatus further comprises means for storing the second tag in the tag store of the plurality of tag stores.

In another aspect, a non-transitory computer readable storage medium stores instructions that upon execution by one or more processors cause the one or more processors to: receive, from a client, a request for a long cache line of data; receive, from the memory, the requested long cache line of data; store the requested long cache line of data into a plurality of data stores across a plurality of memory banks in cache memory as a plurality of short cache lines of data distributed across the plurality of data stores in the cache memory; and store a plurality of tags associated with the plurality of short cache lines of data into one of a plurality of tag stores in the plurality of memory banks in the cache memory.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computing device that may be configured to implement the techniques of this disclosure.

FIG. 2 is a block diagram illustrating the CPU, the GPU and the memory of the computing device of FIG. 1 in further detail.

FIG. 3 is a block diagram illustrating an example of cache memory according to the techniques of this disclosure.

FIG. 4 is a block diagram illustrating an example of a multi-bank cache memory.

FIG. 5 is a block diagram illustrating an example of the multi-bank cache memory of FIG. 4 that includes tag stores for storing tags associated with the data in the multi-bank cache memory.

FIG. 6 illustrates an example operation of the multi-bank cache memory of FIGS. 4 and 5.

FIG. 7 is a block diagram illustrating the cache memory shown in FIGS. 4-6 in further detail.

FIG. 8 is a flowchart illustrating an example process for utilizing a multi-bank cache memory to store and load both long cache lines of data as well as short cache lines of data.

### DETAILED DESCRIPTION

This disclosure is directed to a multi-bank cache memory system that includes multiple memory banks for servicing requests for data from one or more clients. The multi-bank cache memory system may be able to service requests for cache lines of different sizes, and may be able to store such cache lines amongst the multiple memory banks in a manner that improves the performance of the multi-bank cache memory system.

In accordance with some aspects of the present disclosure, example techniques may include a multi-bank cache memory system configured to service requests for short cache lines of data and long cache lines of data, where a short cache line of data has a data size that is smaller than that of a long cache line of data. The multi-bank cache memory system may process a long cache line of data as a plurality of short cache lines of data, and may store the plurality of short cache lines of data representing the long cache line of data across the memory banks of the multi-bank cache memory system. In this way, two or more memory banks of the multi-bank cache memory may be able to read and write two or more of the plurality of short cache lines at the same time, thereby increasing performance of the multi-bank cache memory system.

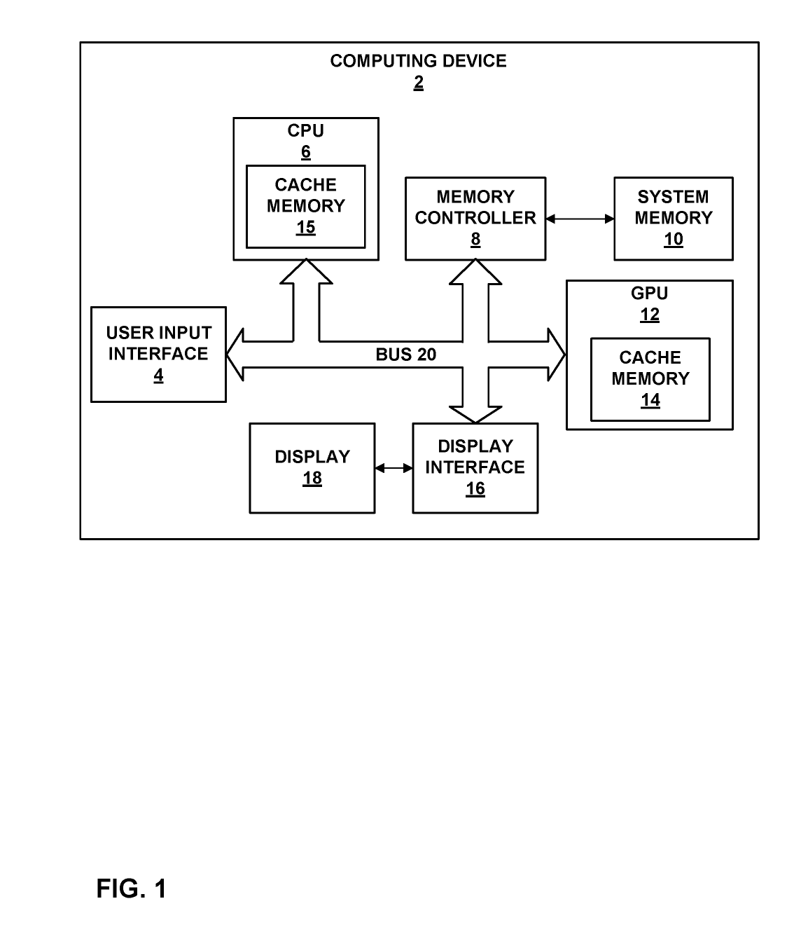

FIG. 1 is a block diagram illustrating an example computing device 2 that may be configured to implement techniques of this disclosure. Computing device 2 may comprise a personal computer, a desktop computer, a laptop computer, a computer workstation, a video game platform or console, a wireless communication device (such as, e.g., a mobile telephone, a cellular telephone, a satellite telephone, and/or a mobile telephone handset), a landline telephone, an Internet telephone, a handheld device such as a portable video game device or a personal digital assistant (PDA), a personal music player, a video player, a display device, a television, a television set-top box, a server, an intermediate network device, a mainframe computer or any other type of device that processes and/or displays graphical data.

As illustrated in the example of FIG. 1, computing device 2 includes a user input interface 4, a CPU 6, a memory controller 8, a system memory 10, a graphics processing unit (GPU) 12, a GPU cache memory 14, a CPU cache memory 15 a display interface 16, a display 18, and bus 20. User input interface 4, CPU 6, memory controller 8, GPU 12, and display interface 16 may communicate with each other using bus 20. Bus 20 may be any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXentisible Interface (AXI) bus) or another type of bus or device interconnect. It should be noted that the specific configuration of buses and communication interfaces between the different components shown in FIG. 1 is merely exemplary, and other configurations of computing devices and/or other graphics processing systems with the same or different components may be used to implement the techniques of this disclosure.

CPU 6 may comprise a general-purpose or a special-purpose processor that controls operation of computing device 2. A user may provide input to computing device 2 to cause CPU 6 to execute one or more software applications. The software applications that execute on CPU 6 may include, for example, an operating system, a word processor application, an email application, a spread sheet application, a media player application, a video game application, a graphical user interface application or another program. The user may provide input to computing device 2 via one or more input devices (not shown) such as a keyboard, a mouse, a microphone, a touch pad or another input device that is coupled to computing device 2 via user input interface 4.

The software applications that execute on CPU 6 may include one or more graphics rendering instructions that instruct CPU 6 to cause the rendering of graphics data to display 18. In some examples, the software instructions may conform to a graphics application programming interface (API), such as, e.g., an Open Graphics Library (OpenGL®) API, an Open Graphics Library Embedded Systems (OpenGL ES) API, a Direct3D API, an X3D API, a RenderMan API, a WebGL API, or any other public or proprietary standard graphics API. In order to process the graphics rendering instructions, CPU 6 may issue one or more graphics rendering commands to GPU 12 to cause GPU 12 to perform some or all of the rendering of the graphics data. In some examples, the graphics data to be rendered may include a list of graphics primitives, e.g., points, lines, triangles, quadralaterals, triangle strips, etc.

Memory controller 8 facilitates the transfer of data going into and out of system memory 10. For example, memory controller 8 may receive memory read and write commands, and service such commands with respect to memory 10 in order to provide memory services for the components in computing device 2. Memory controller 8 is communicatively coupled to system memory 10. Although memory controller 8 is illustrated in the example computing device 2 of FIG. 1 as being a processing module that is separate from both CPU 6 and system memory 10, in other examples, some or all of the functionality of memory controller 8 may be implemented on one or both of CPU 6 and system memory 10.

System memory 10 may store program modules and/or instructions that are accessible for execution by CPU 6 and/or data for use by the programs executing on CPU 6. For example, system memory 10 may store user applications and graphics data associated with the applications. System memory 10 may additionally store information for use by and/or generated by other components of computing device 2. For example, system memory 10 may act as a device memory for GPU 12 and may store data to be operated on by GPU 12 as well as data resulting from operations performed by GPU 12. For example, system memory 10 may store any combination of texture buffers, depth buffers, stencil buffers, vertex buffers, frame buffers, or the like. In addition, system memory 10 may store command streams for processing by GPU 12. System memory 10 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

GPU 12 may be configured to perform graphics operations to render one or more graphics primitives to display 18. Thus, when one of the software applications executing on CPU 6 requires graphics processing, CPU 6 may provide graphics commands and graphics data to GPU 12 for rendering to display 18. The graphics commands may include, e.g., drawing commands such as a draw call, GPU state programming commands, memory transfer commands, general-purpose computing commands, kernel execution commands, etc. In some examples, CPU 6 may provide the commands and graphics data to GPU 12 by writing the commands and graphics data to memory 10, which may be accessed by GPU 12. In some examples, GPU 12 may be further configured to perform general-purpose computing for applications executing on CPU 6.

GPU 12 may, in some instances, be built with a highly-parallel structure that provides more efficient processing of vector operations than CPU 6. For example, GPU 12 may include a plurality of processing elements that are configured to operate on multiple vertices or pixels in a parallel manner. The highly parallel nature of GPU 12 may, in some instances, allow GPU 12 to draw graphics images (e.g., GUIs and two-dimensional (2D) and/or three-dimensional (3D) graphics scenes) onto display 18 more quickly than drawing the scenes directly to display 18 using CPU 6. In addition, the highly parallel nature of GPU 12 may allow GPU 12 to process certain types of vector and matrix operations for general-purpose computing applications more quickly than CPU 6.

GPU 12 may, in some instances, be integrated into a motherboard of computing device 2. In other instances, GPU 12 may be present on a graphics card that is installed in a port in the motherboard of computing device 2 or may be otherwise incorporated within a peripheral device configured to interoperate with computing device 2. In further instances, GPU 12 may be located on the same microchip as CPU 6 forming a system on a chip (SoC). GPU 12 may include one or more processors, such as one or more microprocessors, application specific integrated circuits (ASICs), field programmable gate arrays (FPGAs), digital signal processors (DSPs), or other equivalent integrated or discrete logic circuitry.

GPU 12 may be directly coupled to GPU cache memory 14. GPU cache memory 14 may cache data from system memory 10 and/or graphics memory internal to GPU 12. Thus, GPU 12 may read data from and write data to GPU cache memory 14 without necessarily using bus 20. In some instances, however, GPU 12 may not include a separate cache, but instead may directly access system memory 10 via bus 20. GPU cache memory 14 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), flash memory, a magnetic data media or an optical storage media.

Similarly, CPU 6 may be directly coupled to CPU cache memory 15. CPU cache memory 15 may cache data from system memory. Thus, CPU 6 may read data from and write data to CPU cache memory 15 without necessarily using bus 20. In some instances, however, CPU 6 may not include a separate cache, but instead may directly access system memory 10 via bus 20. CPU cache memory 15 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), flash memory, a magnetic data media or an optical storage media.

CPU 6 and/or GPU 12 may store rendered image data in a frame buffer that is allocated within system memory 10. Display interface 16 may retrieve the data from the frame buffer and configure display 18 to display the image represented by the rendered image data. In some examples, display interface 16 may include a digital-to-analog converter (DAC) that is configured to convert the digital values retrieved from the frame buffer into an analog signal consumable by display 18. In other examples, display interface 16 may pass the digital values directly to display 18 for processing. Display 18 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display or another type of display unit. Display 18 may be integrated within computing device 2. For instance, display 18 may be a screen of a mobile telephone handset or a tablet computer. Alternatively, display 18 may be a stand-alone device coupled to computing device 2 via a wired or wireless communications link. For instance, display 18 may be a computer monitor or flat panel display connected to a personal computer via a cable or wireless link.

GPU 12, alone or in combination with CPU 6, may be configured to perform the example techniques described in this disclosure.

In accordance with an aspect of the present disclosure, CPU cache memory 15 may receive, from a client, a request for a long cache line of data. CPU cache memory 15 may receive, from a memory (e.g., system memory 10), the requested long cache line of data. CPU cache memory 15 may store the requested long cache line of data into a plurality of data stores across a plurality of memory banks as a plurality of short cache lines of data distributed across the plurality of memory banks in CPU cache memory 15. CPU cache memory 15 may also store a plurality of tags associated with the plurality of short cache lines of data into one of a plurality of tag stores in the plurality of memory banks.

In accordance with another aspect of the present disclosure, GPU cache memory 14 may receive, from a client, a request for a long cache line of data. GPU cache memory 14 may receive, from a memory (e.g., system memory 10), the requested long cache line of data. GPU cache memory 14 may store the requested long cache line of data into a plurality of data stores across a plurality of memory banks as a plurality of short cache lines of data distributed across the plurality of memory banks in GPU cache memory 14. GPU cache memory 14 may also store a plurality of tags associated with the plurality of short cache lines of data into one of a plurality of tag stores in the plurality of memory banks.

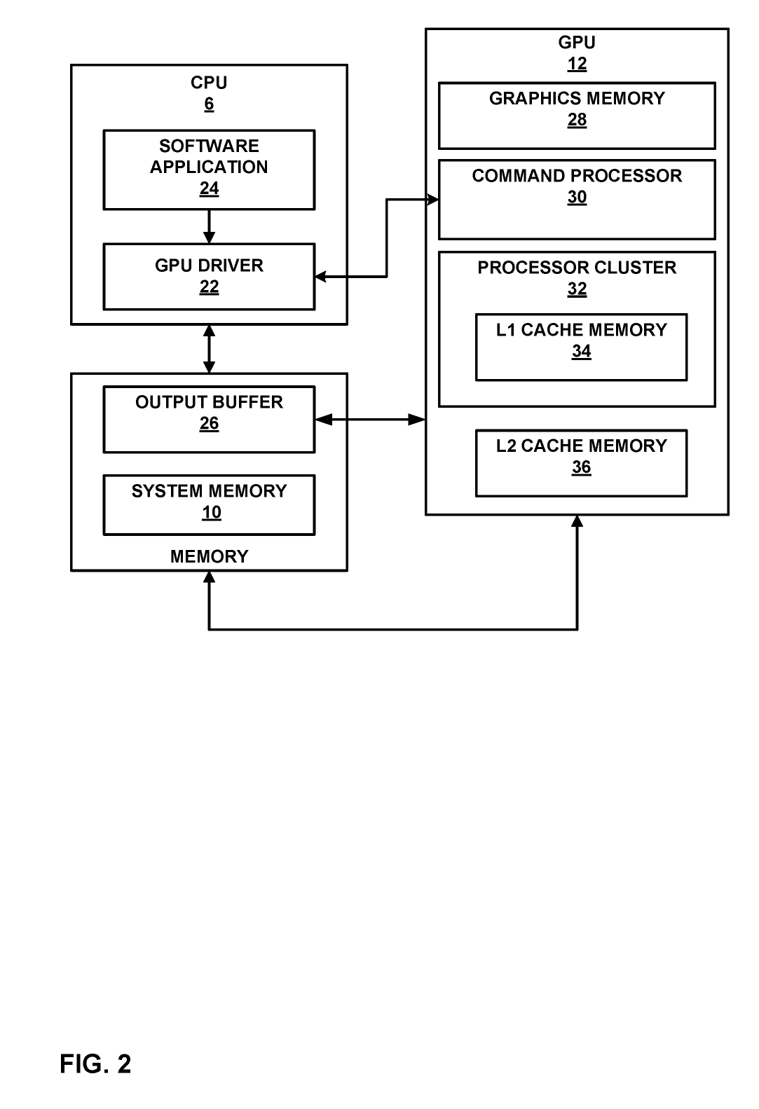

FIG. 2 is a block diagram illustrating CPU 6, GPU 12 and system memory 10 of computing device 2 of FIG. 1 in further detail. As shown in FIG. 2, CPU 6 is communicatively coupled to GPU 12 and memory, such as system memory 10 and output buffer 26, such as via a bus, and GPU 12 is communicatively coupled to CPU 6 and memory, such as via a bus. GPU 12 may, in some examples, be integrated onto a motherboard with CPU 6. In additional examples, GPU 12 may be implemented on a graphics card that is installed in a port of a motherboard that includes CPU 6. In further examples, GPU 12 may be incorporated within a peripheral device that is configured to interoperate with CPU 6. In additional examples, GPU 12 may be located on the same microchip as CPU 6 forming a system on a chip (SoC). CPU 6 is configured to execute software application 24, and a GPU driver 22. GPU 12 includes a command processor 30 and processor cluster 32.

Software application 24 may include at least one of one or more instructions that cause graphic content to be displayed or may include one or more instructions that cause a non-graphics task (e.g., a general-purpose computing task) to be performed on GPU 12. Software application 24 may issue instructions that are received by GPU driver 28.

GPU driver 22 receives the instructions from software application 24 and controls the operation of GPU 12 to service the instructions. For example, GPU driver 22 may formulate one or more command streams, place the command streams into system memory 10, and instruct GPU 12 to execute command streams. GPU driver 22 may place the command streams into memory and communicate with GPU 12, e.g., via one or more system calls.

Command processor 30 is configured to retrieve the commands stored in the command streams, and dispatch the commands for execution on processing cluster 32. Command processor 30 may dispatch commands from a command stream for execution on all or a subset of processing cluster 32. Command processor 30 may be hardware of GPU 12, may be software or firmware executing on GPU 12, or a combination of both.

Processing cluster 32 may include one or more processing units, each of which may be a programmable processing unit (e.g., a shader processor or shader unit) or a fixed function processing unit. A programmable processing unit may include, for example, a programmable shader unit that is configured to execute one or more shader programs (e.g., the consuming shader described above) that are downloaded onto GPU 12 from CPU 6. A shader program, in some examples, may be a compiled version of a program written in a high-level shading language, such as, e.g., an OpenGL Shading Language (GLSL), a High Level Shading Language (HLSL), a C for Graphics (Cg) shading language, etc. In some examples, a programmable shader unit may include a plurality of processing units that are configured to operate in parallel, e.g., an SIMD pipeline. A programmable shader unit may have a program memory that stores shader program instructions and an execution state register, e.g., a program counter register that indicates the current instruction in the program memory being executed or the next instruction to be fetched. The programmable shader units in processing cluster 32 may include, for example, consuming shader units, vertex shader units, fragment shader units, geometry shader units, hull shader units, domain shader units, compute shader units, and/or unified shader units.

A fixed function processing unit may include hardware that is hard-wired to perform certain functions. Although the fixed function hardware may be configurable, via one or more control signals for example, to perform different functions, the fixed function hardware typically does not include a program memory that is capable of receiving user-compiled programs. In some examples, the fixed function processing units in processing cluster 32 may include, for example, processing units that perform raster operations, such as, e.g., depth testing, scissors testing, tessellation, alpha blending, etc.

In some examples, GPU cache memory 14 may comprise multi-level cache memory, so that GPU 12 may include level 1 (L1) cache memory 34 as well as level 2 (L2) cache memory 36 that may cache data from system memory 10, graphics memory 28, or other memory. In some examples, the multi-level cache memory may also include one or more additional levels of cache memory, such as level 3 (L3) cache memory, level 4 (L4) cache memory, and the like.

Processing cluster 32 may include level 1 (L1) cache memory 34 that caches data for use by the one or more processing units of processing cluster 32. In some examples, each of the one or more processing units of processing cluster 32 may include its own separate L1 cache memory 34. In other examples, the one or more processing units of processing cluster 32 may share L1 cache memory 34. Typically, L1 cache memory 34 may be smaller and faster than L2 cache memory 36. In other words, L1 cache memory 34 may be able to store less data than L2 cache memory 36, but processing cluster 32 may be able to more quickly access L1 cache memory 34 compared with L2 cache memory 36.

When one or more processing units of processing cluster 32 requests data from system memory 10 or graphics memory 28, L1 cache memory 34 may first attempt to service the request for data by determining whether the requested data is stored in L1 cache memory 34. If the requested data is stored in L1 cache memory 34, L1 cache memory 34 may return the requested data to the one or more processing units of processing cluster 32.

If the requested data is not stored in L1 cache memory 34, then L2 cache memory 36 may attempt to service the request for data by determining whether the requested data is stored in L2 cache memory 36. As discussed above, L2 cache memory 36 may store relatively more data than L1 cache memory 34. In some examples, L1 cache memory 34 may store a subset of the data stored in L2 cache memory 36. If the requested data is stored in L2 cache memory 36, GPU 12 may write the requested data into L1 cache memory 34, and L1 cache memory 34 may return the requested data to the one or more processing units of processing cluster 32.

If the requested data is not stored in L2 cache memory 36, GPU 12 may retrieve the requested data from system memory 10 or graphics memory 28. GPU 12 may write the requested data into L2 cache memory 36 and into L1 cache memory 34, and L1 cache memory 34 may return the requested data to the one or more processing units of processing cluster 32. In this way, if the one or more processing units of processing cluster 32 later requests the same data, processing cluster 32 may be able to more quickly receive the requested data because the requested data is now stored in L1 cache memory 34.

In accordance with an aspect of the present disclosure, L2 cache memory 36 may receive, from a client (e.g., L1 cache memory 34), a request for a long cache line of data. L2 cache memory 36 may receive, from system memory 10 or graphics memory 28, the requested long cache line of data. L2 cache memory 36 may store the requested long cache line of data into a plurality of data stores as a plurality of short cache lines of data distributed across a plurality of memory banks in L2 cache memory 36. L2 cache memory 36 may also store a plurality of tags associated with the plurality of short cache lines of data into one of a plurality of tag banks in L2 cache memory 36.

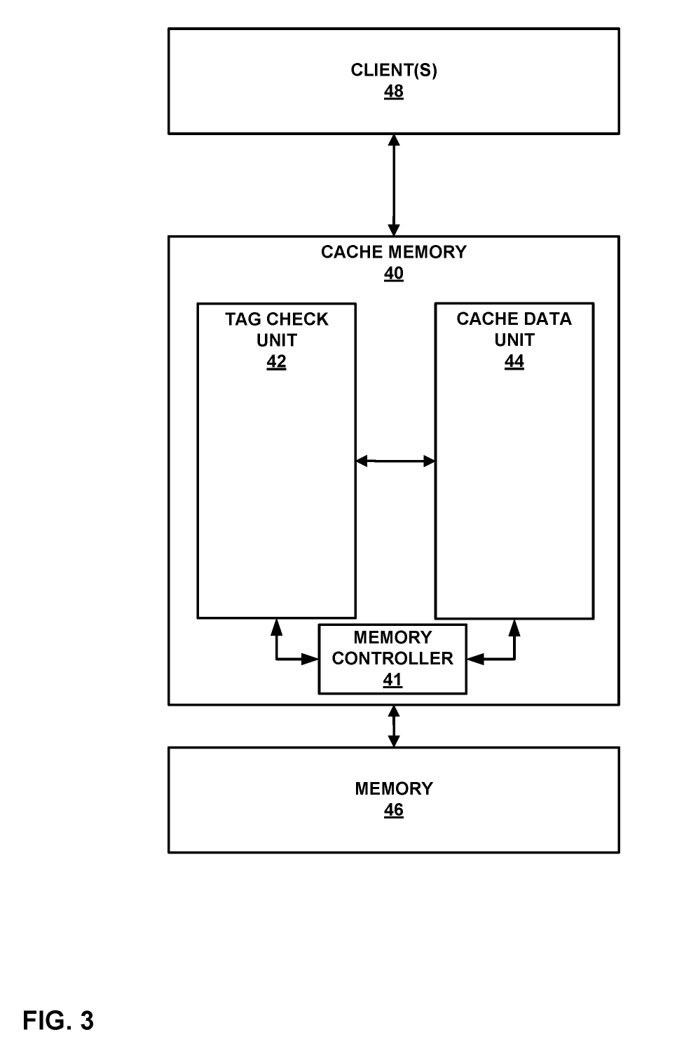

FIG. 3 is a block diagram illustrating an example of cache memory 40 that may be used by CPU 6 and/or GPU 12. In some examples, cache memory may be an example of CPU cache memory 15 or GPU cache memory 14 of FIG. 1, or may, in some examples, be an example of L1 cache memory 34 and/or L2 cache memory 36 of GPU 12 shown in FIG. 2. As shown in FIG. 0.3, cache memory 40 may receive a request for data from one or more clients 48. Cache memory 40 may determine whether it has stored a copy of the requested data. If cache memory 40 determines that it has stored a copy of the requested data, cache memory 40 may return the requested data to one or more clients 48. If cache memory 40 determines that it has not stored a copy of the requested data, cache memory 40 may retrieve the requested data from memory 46, store the requested data retrieved from memory 46, and return the requested data to one or more clients 48.

If cache memory 40 is used by CPU 6, one or more clients 48 may include CPU 6, and memory 46 may include system memory 10. If cache memory 40 is L1 cache memory 34, one or more clients 48 may include one or more processing units of processor cluster 32, and memory 46 may include L2 cache memory 36. If cache memory 40 is L2 cache memory 36, one or more clients 48 may include L1 cache memory 34, and memory 46 may include system memory 10 and/or graphics memory 28.

Cache memory 40 may include tag check unit 42 and cache data unit 44. Cache data unit 44 may be configured to store a subset (fewer than all) of the data in memory 46 as well as other information associated with the data stored in cache data unit 44, such as tags associated with the data as well as one or more bits (e.g., a valid bit) associated with each of the data. Tag check unit 42 may be configured to perform tag checking to determine whether a request for data received by cache memory 40 from one or more clients 48 can be fulfilled by cache memory 40.

In other words, cache memory 40 may receive a request for data from one or more clients 48. The request for data may include or otherwise indicate the requested data's address in memory 46. The requested data's address in memory 46 may be a virtual address, a physical address, and the like. Tag check unit 42 may perform tag checking for the requested data in part by generating a tag for the requested data from the requested data's address in memory 46 (e.g., the requested data's virtual address in memory 46), so that the tag for the requested data may include a portion of its address in memory 46.

Tag check unit 42 may compare the tag for the requested data against the tags that are associated with the data stored in cache data unit 44. If the tag for the requested data matches one of the tags that are associated with the data stored in cache data unit 44, tag check unit 42 may determine that the requested data is stored in cache data unit 44, and cache memory 40 may retrieve the requested data from cache data unit 44 and return the requested data to one or more clients 48.

On the other hand, if the tag for the requested data does not match any of the tags stored in cache data unit 44, tag check unit 42 may determine that the requested data is not stored in cache data unit 44. Instead, cache memory 40 may retrieve the requested data from memory 46. Upon retrieving the requested data, cache memory may store the tag for the requested data as well as the requested data itself into cache data unit 44, and return the requested data to one or more clients 48. In this way, cache memory 40 may update itself to store data that was requested by one or more clients 48.

Cache memory 40 may also include memory controller 41. Memory controller 41 may be hardware circuitry and/or hardware logic (e.g., a digital circuit) that manages the flow of data to and from cache memory 40, as well as the reading and writing of data and tags to and from cache data unit 44 and tad check unit 42. Although shown as being a part of cache memory 40, memory controller 41 may, in some cases, be situated outside of cache memory 40, such as in CPU 6, GPU 12, or elsewhere in computing device 2. In some examples, memory controller 41 may be memory controller 8 shown in FIG. 1.

Throughout this disclosure, although cache memory 40 is described as acting to perform a function, it should be understood that cache memory 40 may be configured to use memory controller 41 to perform many of those functions, including but not limited to performing tag checking, allocating space within cache data unit 44, writing and retrieving data to and from cache data unit 44, and the like.

Data may be transferred between one or more clients 48 and cache memory 40, as well as between cache memory 40 and memory 46, in blocks of fixed size called cache lines or cache blocks. Therefore, when one or more clients 48 sends a request for data to cache memory 40, one or more clients 48 may be sending a request for a cache line of data. Furthermore, cache memory 40 may retrieve the requested data from memory 46 by receiving a cache line of data from memory 46. Cache lines, in some examples, may comprise 8 bytes (B) of data, 16B of data, 32B of data, 64B of data, 128B of data, 256B of data, and the like.

In some example, a piece of data stored in cache data unit 44 may be referred to as a cache entry. A cache entry may correspond to a cache line of cache memory 40, so that a cache entry in cache data unit 44 may be the same size as the cache line of cache memory 40. Thus, when cache memory 40 receives a cache line of data from memory 46, cache memory 40 may allocate a cache entry in cache data unit 44 and store the cache line of data into the allocated cache entry in cache data unit 44. In other examples, a cache line may occupy multiple cache entries in cache data unit 44.

In accordance with an aspect of the present disclosure, cache memory 40 may support data requests of different granularities from one or more clients 48. Data requests of different granularities may be requests for data of different sizes. For example, cache memory 40 may support requests for 32B of data as well as requests for 64B of data. A request for data of a particular size at a particular memory address may be a request for data from contiguous memory locations starting at a particular memory address. For example, if each memory location in memory 46 contains 8B of data, and if one or more clients 48 sends a request for 32B of data from a particular memory address, cache memory may retrieve 32B of data from four contiguous 8B memory locations within memory 46, starting from the memory location specified by the particular memory address, and may return the retrieved 32B of data to one or more clients 48. By supporting data requests of different granularities, cache memory 40 may enable one or more clients 48 to send a single request to retrieve a relatively large amount of data instead of sending multiple requests for relatively smaller amounts of data in order to retrieve the same amount of data, thereby making data retrieval more efficient for one or more clients 48 and cache memory 40.

In accordance with aspects of the present disclosure, cache memory 40 may support data requests of different granularities by supporting cache lines of different sizes. In some examples, cache memory may support both a short cache line and a long cache line. A short cache line may be a cache block having a fixed data size that is smaller than the fixed data size of a cache block represented as a long cache line. For instance, a short cache line may be a 64B cache block while a long cache line may be a 256B cache block. In some examples, cache memory 40 may support a long cache line having a data size that is an integer multiple of the data size of a short cache line supported by memory 40. For example, a long cache line may have a data size that is two times or four times the data size of a short cache line.

By supporting both short cache lines and long cache lines, cache memory 40 may enable one or more clients 48 to more efficiently retrieve relatively large portions of data by making fewer requests for data. For example, if a short cache line is a 64B cache block, and if a long cache line is a 256B cache block, one or more clients 48 may be able to request 512B of data by making two requests for long cache lines of data, instead of making eight requests for short cache lines of data.

However, if cache memory 40 only supported a single, relatively large, cache line, such as the example 256B cache line, cache memory 40 may increase the amount of over fetching as well as memory pressure. For example, if one or more clients 48 would like to request 32B of data from cache memory 40, but cache memory 40 only supports 256B cache lines, one or more clients 48 may send a request for a 256B cache line worth of data from cache memory 40 in order to retrieve the 32B of data from cache memory 40, thereby over fetching data from cache memory 40. Further, if cache memory 40 determines that it does not store a copy of the requested data, cache memory 40 may then request the 256B of data from memory 46, even though one or more clients 48 may only be interested in 32B of data out of the 256B of data. In addition, cache memory 40 may also need to clear out one or more cache entries in cache data unit 44 to make space to store the 256B of data received from memory 46, when one or more clients 48 may only be interested in 32B of data out of the 256B of data. As such, only supporting cache lines of a single, relatively large, size may be inefficient with regards to usage of bandwidth as well as cache memory 40.

As such, in addition to supporting long cache lines, cache memory 40 may also support short cache lines. By supporting both long cache lines and short cache lines, cache memory 40 may enable one or more clients 48 to send requests for long cache lines of data when requesting relatively large chunks of data, while enabling one or more clients 48 to send requests for short cache lines of data when requesting relatively small chunks of data, thereby enabling more efficient use of cache memory 40. When one or more clients 48 sends a request for data to cache memory 40, the request for data may indicate whether one or more clients 48 is requesting a short cache line of data or a long cache line of data. For example, the request from one or more clients 48 may include a flag, bit, or any other suitable indication regarding whether the request is a request for a short cache line of data or a request for a long cache line of data.

In some examples, cache memory 40 may treat a short cache line as a basic unit of data in cache memory 40, like how cache memory 40 may treat a cache line if cache memory 40 only supported a single cache line size. The size of cache entries in cache data unit 44 of cache memory 40 may be the same as the size of short cache lines supported by cache memory 40. Therefore, in these examples, a single short cache line of data may be stored in a single cache entry in cache data unit 44.

Cache memory 40 may support long cache lines in addition to short cache lines by processing long cache lines within cache memory 40 like an aggregation of short cache lines. The size of a long cache line of data may be an integer multiple of the size of a short cache line. Thus, when cache memory 40 receives a request for a long cache line of data from one or more clients 48, and if cache memory 40 determines that cache data unit 44 does not contain a copy of the requested data, cache memory 40 may allocate a plurality of short cache lines in cache data unit 44 to store the requested long cache line of data when it is retrieved from memory 46.

When cache memory 40 receives the requested long cache line of data from memory 46, cache memory 40 may disaggregate the long cache line of data into a plurality of short cache lines of data. In other words, cache memory 40 may break the long cache line of data into a plurality of short cache lines of data by storing the long cache line of data into the plurality of short cache lines allocated in cache data unit 44 as a plurality of short cache lines of data. Cache memory 40 may treat each of the plurality of short cache lines of data as an individual short cache line within cache memory 40. For example, if a short cache line is a 64B cache block of data, and if a long cache line is a 256B cache block of data, cache memory 40 may break the 256B long cache line of data into four 64B short cache lines of data stored into four short cache lines allocated in cache data unit 44.

Instead of associating a single tag and a single set of flag bits for a long cache line of data, each of the plurality of short cache lines of data may be associated with its own set of flag bits as well as its own tag in cache memory 40. Flag bits may include valid bits, dirty bits, and/or any other suitable bits associated with data in cache memory 40. Because each of the plurality of short cache lines of data is associated with its own tag, each of the plurality of short cache lines of data may be addressed separately by its associated address in memory 46. In the example of a 256B long cache line of data that is broken into four 64B short cache lines of data, a first short cache line of data may have the same memory address as the long cache line of data in memory 46, a second short cache line of data may have a memory address that is offset by 64B from the first short cache line of data, a third short cache line of data may have a memory address that is offset by 64B from the second short cache line of data, and a fourth short cache line of data may have a memory address that is offset by 64B from the third short cache line of data. In this way, cache memory 40 may generate different tags for each of the plurality of short cache lines of data.

Thus, one or more clients 48 may be able to, at a later point, read from or write to a subset of the long cache line of data that is now stored in cache memory 40 as a plurality of short cache lines of data by addressing the individual short cache lines of data by its respective memory address. One or more clients 48 may read a short cache line of data from a memory address associated with one of the plurality of short cache lines of data, and may also be able to update a subset of the long cache line of data, such as by writing data to one of the plurality of short cache lines of data.

To increase the throughput of cache memory 40, cache memory 40 may be a multi-bank cache memory that utilizes multiple memory banks for storing data. A multi-bank cache memory may be cache memory 40 that includes a plurality of memory banks, and individual memory banks in the plurality of memory banks may each include a data store that services requests independent of the other data stores in other memory banks, which may be useful for servicing requests for data from multiple clients. In some examples, a multi-bank cache system may be referred to as multichannel memory. In some examples, each memory bank of the plurality of memory bank may be a separate memory module, such as a separate piece of memory hardware.

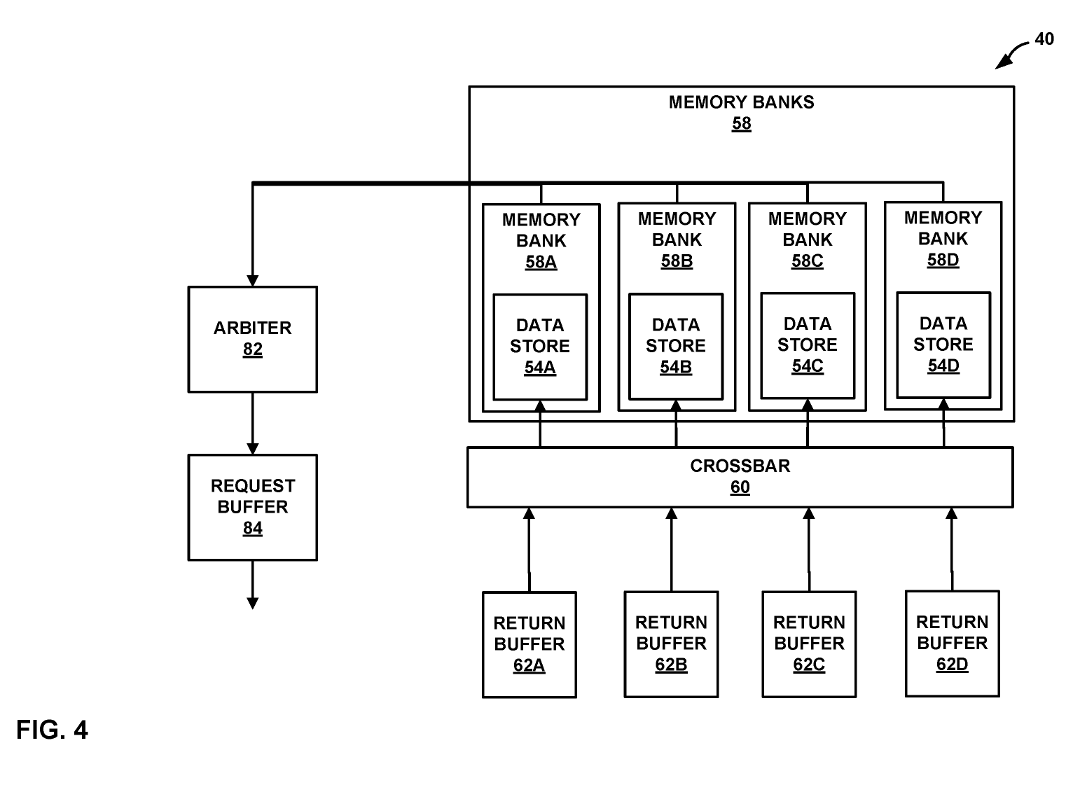

FIG. 4 is a block diagram illustrating an example of a multi-bank cache memory. As shown in FIG. 4, cache data unit 44 of cache memory 40 may include memory banks 58A-58D (“memory banks 58”). A portion of each of memory banks 58 may be allocated as data stores 54A-54D (“data stores 54”), so that each memory bank (e.g., memory bank 58A) of memory banks 58 is a memory module that includes an individual data store (e.g., data store 54A) for storing at least a portion of the data stored in cache memory 40. Although cache data unit 44 is shown has having four memory banks 58 in the example of FIG. 4, cache data unit 44 may, in some examples, contain any number of two or more memory banks, such as four memory banks, eight memory banks, and the like.

Each memory bank of memory banks 58 may be static random access memory (SRAM), dynamic random access memory (DRAM), a combination of SRAM and DRAM, or any other suitable random access memory. Return buffers 62A-62D (“return buffers 62”) may be able to buffer data returned from memory 46 to be written into data stores 54 in memory banks 58. Crossbar 60 may channel data between return buffers 62 and memory banks 58 so that data buffered in return buffers 62 for writing into data stores 54 in memory banks 58 are routed to the appropriate memory bank of memory banks 58. By splitting cache memory 40 into multiple memory banks 58, two or more of memory banks 58 may be able to service requests at the same time. For example, one memory bank of memory banks 58 may read or write data at the same time another memory bank of memory bank 58 is reading or writing data. As such, by utilizing multiple memory banks 58, cache memory 40 may increase its throughput compared with single bank or single channel cache memory systems.

In some examples, cache memory 40 may organize memory banks 58 so that short cache lines of data occupying linear addresses in memory (e.g., a virtual address space) are distributed across data stores 54 of different memory banks of memory banks 58. In other words, cache memory 40 may store short cache lines of data that are contiguous in the address space into different memory banks of memory banks 58. Due to spatial locality of reference, if data at a particular location in the address space is likely to be frequently accessed, then other data within relatively close storage locations (e.g., address space) of that data are also likely to be frequently accessed. By distributing data occupying linear addresses across different memory banks of memory banks 58, cache memory 40 may enable such data occupying linear addresses to be accessed at the same time, as opposed to accessing such data sequentially in the example of storing such data in the same single port memory bank of memory banks 58.

As discussed above, cache memory 40 may support both short cache lines as well as long cache lines. In one example, cache memory 40 may store a long cache line of data in the data store of a single memory bank of memory banks 58. However, storing a long cache line of data into the data store of a single memory bank may require several consecutive writes into the memory bank, thereby blocking clients from reading data out of the memory bank. This may happen if the memory bank is, for example, a single port SRAM. In this example, a long cache line of data may be 256B, each memory bank of memory banks 58 may be able to read or write at a rate of 32B per cycle, and memory 46 may be able to return data at a rate of 128B per cycle. If a long cache line of data is stored in a single memory bank, the memory bank may require a relatively large return buffer to store data returned by memory 46 at a rate of 128B per cycle, while writing data into a memory bank at a rate of 32B per cycle.

In accordance with aspects of the present disclosure, cache memory 40 may process a long cache line of data as a plurality of short cache lines of data, and may store the plurality of short cache lines of data into data stores 54 of different memory banks of memory banks 58. In one example, cache memory 40 may disaggregate long cache line of data having a size of 256B into four short cache lines of data each having a size of 64B by dividing the 256B long cache line of data into four 64B portions and writing the four 64B portions into four 64B-sized short cache lines. If memory banks 58 include four memory banks, cache memory 40 may be able to write the four short cache lines into the four memory banks at the same time. In this example, if each memory bank of memory banks 58 is able to read or write data at a rate of 32B per cycle, and memory 46 may be able to return data at a rate of 128B per cycle, memory banks 58 may be able to match the 128B per cycle rate at which memory 46 returns the data because each of the four memory banks may be able to write data at 32B per cycle, and because 32B per cycle multiplied by four memory banks may equal a write rate of 128B per cycle.

By writing data into its individual memory banks at the same time, memory banks 58 may be able to match the rate at which memory 46 returns the data. Thus, the associated return buffers for memory banks 58 may be relatively small without the need to store data returned by memory 40 that is waiting to be written into memory banks 58. Instead, the size of the return buffers may only need to account for the internal latency of memory banks 58. As such, techniques of the present disclosure may also enable cache memory 40 to include relatively small return buffers for memory banks 58 compared with techniques that write a long cache line of data into a single memory bank.

Cache memory 40 may also include arbiter 82 configured to control access to memory banks 58. For example, arbiter 82 may determine which one of a plurality of clients may access memory banks 58 to read data from memory banks 58. Such data that is read out of memory banks 58 may be queued (such as in a first-in-first-out fashion) in request buffer 84.

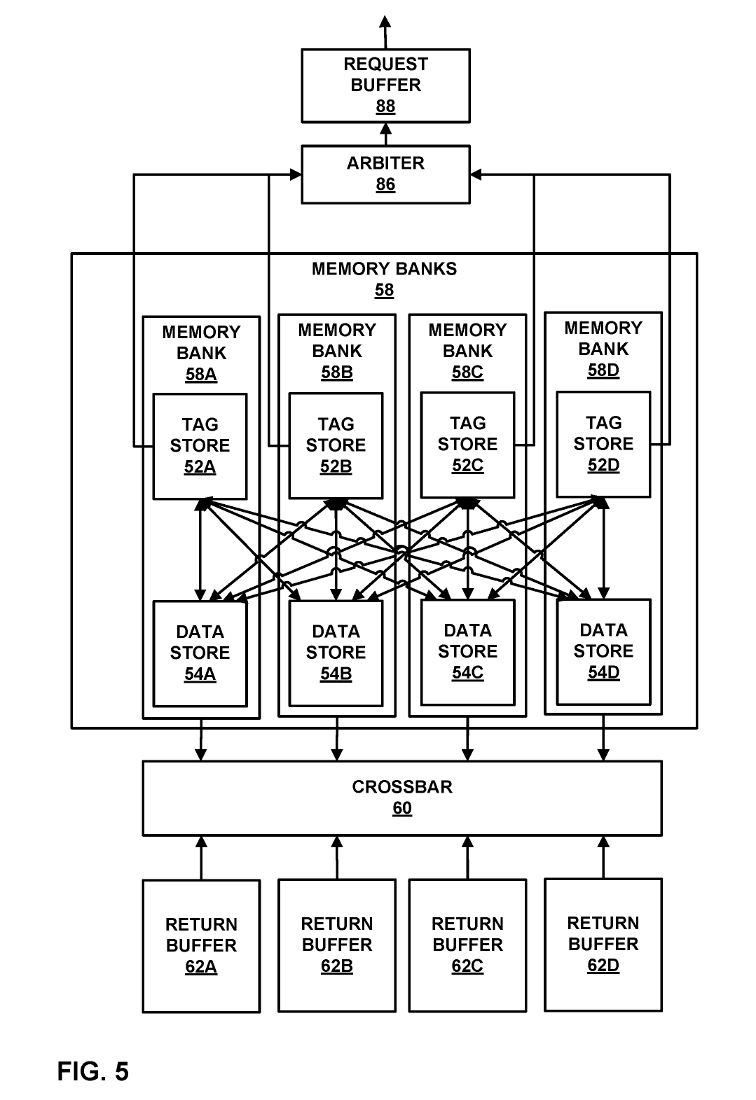

Cache memory 40 may also store tags for the data in cache memory 40 into multi-bank memory, such as memory banks 58. FIG. 5 is a block diagram illustrating an example of the multi-bank cache memory of FIG. 4 that includes tag stores for storing tags associated with the data in the multi-bank cache memory. As shown in FIG. 5, cache memory may include tag stores 52A-52D (“tag stores 52”) in memory banks 58 to store the tags for data stored in data stores 54 of memory banks 58. Similar to data stores 54, tag stores 52 may be memory allocated within each of memory banks 58 for storing tag information associated with the data stored in data stores 54 of memory banks 58. By storing tags into tag banks 52, cache memory 40 may utilize different tag banks of tag banks 52 to perform tag checking operations for multiple requests at the same time.

As discussed above, cache memory 40 may treat a long cache line of data as a plurality of short cache lines of data, so that cache memory 40 may store a long cache line of data as a plurality of short cache lines of data in memory banks 58. For example, cache memory 40 may generate a plurality of short cache lines, and store the long cache line of data into the plurality of short cache lines as a plurality of short cache lines of data, so that each short cache line of data includes at least a different sub-portion of the long cache line of data. Each short cache line of data may be associated with a tag and one or more additional bits (e.g., a dirty bit and a valid bit). Thus, a long cache line of data may be represented in cache memory 40 as a plurality of short cache lines of data associated with a plurality of tags.

Instead storing tags associated with data in the same memory bank as the data (e.g., only storing in tag store 52A tags associated with data stored in data store 54A), cache memory 40 may disassociate tag stores 52 with data stores 54 of the same memory bank, so that the tag store of a single memory bank (e.g., tag store 52A of memory bank 58A) may store tags associated with data from a plurality of different memory banks of memory banks 58. Cache memory 40 may store each of the tags associated with the plurality of short cache lines of data representing a long cache line of data into a single tag store of tag stores 52, while storing the plurality of short cache lines of data associated with the tags across multiple memory banks of memory banks 58. For example, if cache memory 40 stores a long cache line of data as four short cache lines of data, cache memory 40 may store the tags for the four cache lines of data into a single tag store (e.g., tag store 52A) of a single memory bank (e.g., memory bank 58A), and may store the four short cache lines of data across data stores 54 of four memory banks 58A-58D, so that each of the four memory banks 58A-58D stores one of the four short cache lines of data.

In one example, one or more clients 48 may request from cache memory 40 a long cache line of data. The request may include an indication of the address of the data as well as an indication of whether the request is a request for a long cache line of data or a request for a short cache line of data. For example, the request may include a bit that may be set to indicate that the request is a request for a long cache line of data, and may not be set to indicate that the request is a request for a short cache line of data.

Cache memory 40 may receive from one or more clients 48 the request for a long cache line of data and may, in response, determine whether the requested data is stored in memory banks 58 by tag checking the address of the data. If cache memory 40 determines that the requested data is stored in one of memory banks 58, cache memory 40 may return the requested data from the memory banks 58 to one or more clients 48. Because cache memory 40 stores a long cache line of data as a plurality of short cache lines of data spread across memory banks 58, cache memory 40 may aggregate the plurality of short cache lines of data and return the aggregated plurality of short cache lines of data as the requested long cache line of data to the requesting one or more clients 48.

If cache memory 40 determines that the requested data is not stored in memory banks 58, cache memory 40 may request the long cache line of data from memory 46, and may allocate a plurality of short cache lines in data stores 54 of memory banks 58 for storing the long cache line of data. Cache memory 40 may receive the requested long cache line of data from memory 46 and may, in response, store the requested long cache line of data into the plurality of allocated short cache lines, so that the requested long cache line of data is stored across memory banks 58 as a plurality of short cache lines of data.

For example, if the long cache line of data has a size of 256B, cache memory 40 may store the first 64B portion of the long cache line of data into a first memory bank of memory banks 58, store the second 64B portion of the long cache line of data into a second memory bank of memory banks 58, store the third 64B portion of the long cache line of data into a third memory bank of memory banks 58, and store the fourth 64B portion of the long cache line of data into a fourth memory bank of memory banks 58.

Cache memory 40 may derive a tag for each of the plurality of short cache lines of data stored in memory banks 58. Cache memory 40 may derive such tags based on any suitable technique for generating tags for data in cache memory 40, including deriving such tags based on the addresses of each of the plurality of short cache lines of data. To derive the tags, cache memory 40 may derive memory addresses in the memory address space (e.g., virtual memory space) for the plurality of short cache lines based at least in part on the memory address of the long cache line of data in the memory address space. For example, if the long cache line of data has a size of 256B at a memory address, and if each short cache line of data has a size of 64B, the first short cache line of data may have the same address as the long cache line of data, the address of the second short cache line of data may be offset by 64B from the address of the first short cache line of data, the address of the third short cache line of data may be offset by 64B from the address of the second short cache line of data, and the address of the fourth cache line of data may be offset by 64B from the address of the third short cache line of data.

Cache memory 40 may store the tags for the plurality of short cache lines of data that represent the requested long cache line of data into the tag store of a single memory bank of memory banks 58. For example, cache memory 40 may store each of the tags for the plurality of short cache lines of data into the same tag store (e.g., tag store 52A). In some examples, cache memory 40 may store each of the tags for the plurality of short cache lines of data into contiguous memory locations of the same tag store.

Cache memory 40 may store the plurality of short cache lines of data that represent the requested long cache line of data across a plurality of memory banks in memory banks 58A. For example, if memory banks 58 include four memory banks, and if cache memory 40 disaggregates a long cache line of data into four short cache lines of data, cache memory 40 may store a different one of the four short cache lines of data into each of the four memory banks of memory banks 58A. In another example, if memory banks 58 include two memory banks, cache memory 40 may store two of the four short cache lines of data into a first memory bank of memory banks 58, and may store the other two of the four short cache lines of data into a second memory bank of memory banks 58. In this way, cache memory 40 stores the tags for a plurality of short cache lines in a single tag store of a single memory bank, while storing the plurality of short cache lines across multiple memory banks of memory banks 58.

Cache memory 40 may also include arbiter 86 configured to control access to tags stored in tag stores 52. For example, arbiter 86 may determine which one of a plurality of clients may access memory banks 58 to access tag data stored within a particular tag store of a memory bank. Such tag data that is accessed may be queued (such as in a first-in-first-out fashion) in request buffer 88. In this way, tag stores 52 may be accessed in an orderly fashion.

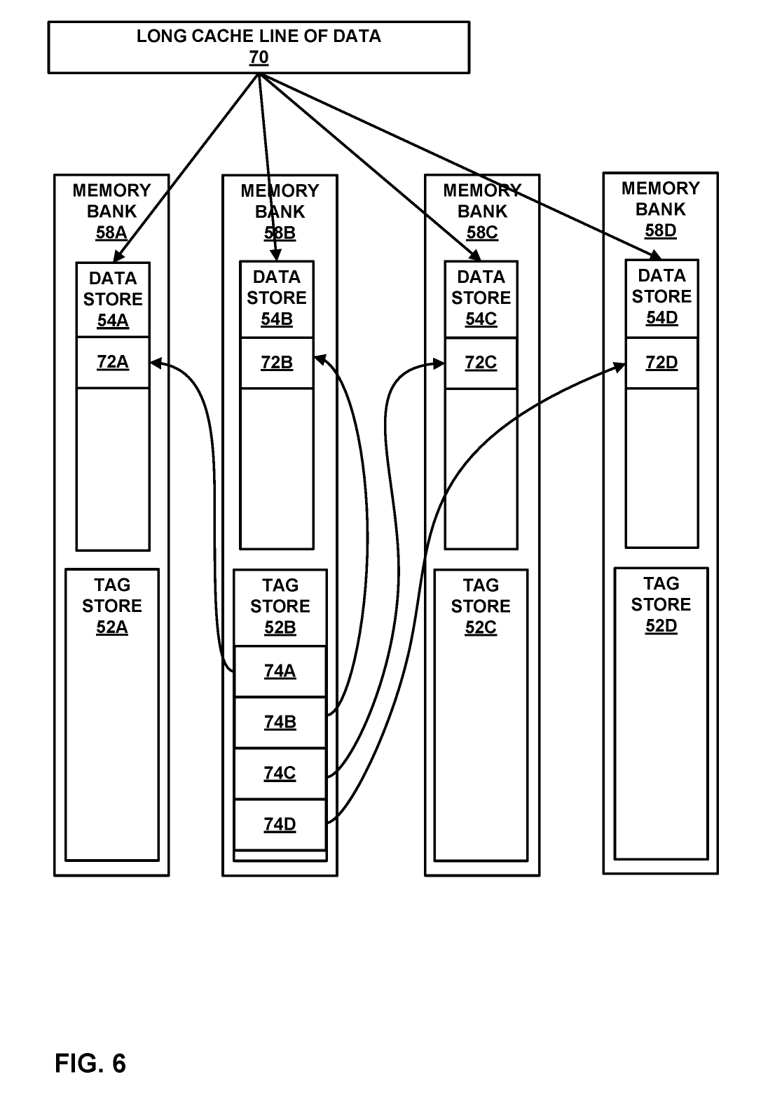

FIG. 6 illustrates an example operation of the multi-bank cache memory of FIGS. 4 and 5. As shown in FIG. 6, in response to a cache miss, which may occur in response to cache memory 40 receiving a request for a long cache line of data that is not stored in cache memory 40, cache memory 40 may retrieve the requested long cache line of data 70 from memory 46 to store into cache memory 40. A cache miss may occur when cache memory 40 receives a request for data that is not stored in cache memory 40. Thus, in the example of FIG. 5, cache memory 40 may retrieve long cache line of data 70 from memory 46 in response to receiving a request for long cache line of data 70.

As discussed above, cache memory 40 may support requests for data of varying sizes, so that cache memory 40 may be able to service both a request for a short cache line of data as well as a request for a long cache line of data (e.g., long cache line of data 70). A request for a long cache line of data may be a request for a relatively larger granularity of data than a request for a short cache line of data. Receiving and servicing a single request for a long cache line of data differs from receiving and requesting a plurality of requests for short cache lines of data. Not only does cache memory 40 receive a single request in the case of a long cache line of data instead of a plurality of requests in the case of a plurality of short cache lines of data, cache memory 40 also issues a single request for a long cache line of data to memory 46 and, in response, receives a long cache line of data to memory 46. In this way, cache memory 40 may receive the long cache line of data from memory 46 as a single transaction, and may also send the long cache line of data to the requesting client as a single transaction.

In response to retrieving long cache line of data 70 from memory 46, cache memory 40 may store long cache line of data 70 into data stores 54 of memory banks 58 as a plurality of short cache lines of data 72A-72D (“short cache lines of data 72”) that are distributed across memory banks 58. By storing long cache line of data 70 as a plurality of short cache lines of data 72, cache memory 40 stores short cache lines of data 72 that contains all of the data in long cache line of data 70. Each short cache line of data in the plurality of short cache lines of data in memory banks 58 stores a sub portion of the data in long cache line of data 70. For example, if long cache line of data 70 comprises 128B of data, short cache line of data 72A may be the first 32B of long cache line of data 70, short cache line of data 72B may be the second 32B of long cache line of data 70, short cache line of data 72C may be the third 32B of long cache line of data 70, and short cache line of data 72D may be the fourth 32B of long cache line of data 70. In this way, cache memory 70 may divide long cache ling of data 70 into the plurality of short cache lines of data 72.

Cache memory 40 may generate tags 74A-74D associated with short cache lines of data 72 based on the memory addresses of short cache lines of data 72. In the example where memory 46 is represented by a virtual address space, cache memory 40 may use any suitable tag generation technique to generate tags 74 based on the memory addresses of each of short cache lines of data 72 in the virtual address space. Thus, each of tags 74 associated with short cache lines of data 72 may be different from each other, so that a tag of tags 74's presence in cache memory 40 may indicate that the tag's associated short cache line of data is stored in cache memory 40.

Cache memory 40 may distribute short cache lines of data 72 across memory banks 58 instead of allocating space in a single memory bank (e.g., memory bank 58B) for short cache lines of data 72. In the example of FIG. 5, cache memory 40 distributes short cache lines of data 72 across memory banks 58A by allocating space in data store 54A of memory bank 58A for short cache line of data 72A, allocating space in data store 54B of memory bank 58B for short cache line of data 72B, allocating space in data store 54C of memory bank 58C for short cache line of data 72C, and allocating space in data store 54D of memory bank 58D for short cache line of data 72D. Thus, if memory 46 is able to provide long cache line of data 70 at a faster rate than any individual memory bank is able to write data cache memory 40 may write data into the short cache lines of data 72 of two or more of memory banks 58 at the same time, thereby increasing the performance of cache memory 40 in storing short cache lines of data 72.

Cache memory 40 may store tags 74 associated with short cache lines of data 72 into a single tag store (e.g., tag store 52B) of tag stores 52 in cache memory 40. In the example of FIG. 6, because each memory bank includes a single tag store, storing tags 74 into a single tag store may include storing tags 74 into a single memory bank (e.g., memory bank 58B) of memory banks 58. Cache memory 40 may also store tags 74 into contiguous locations within the same tag store. By storing tags 74 into contiguous locations within the same tag store, cache memory 40 may, if it at a later point receives a request for the same long cache line of data 70, be able to more easily find all of tags 74 by incrementing the address within the same tag store in order to determine whether associated data is stored within cache memory 40.

For example, when cache memory 40 receives a request for the same long cache line of data 70 that was previously retrieved from memory 46, the request may indicate the memory address of long cache line of data 70 along with an indication that the request is for a long cache line of data. From the memory address, cache memory 40 may determine tag 74A associated with short cache line of data 72A. By storing tags 74 in contiguous locations of a single tag store of a single memory bank, cache memory 40 may, by finding tag 74A, be able to then determine the locations of tags 74B, 74C, and 74D by simply incrementing the address in the tag store, in order to, in part, determine whether short cache lines of data 72 is stored in cache memory 40. If cache memory 40 determines that short cache lines of data 72 are stored in cache memory 40 and are valid (e.g., have their corresponding valid bits set), then cache memory 40 may be able to return short cache lines of data 72 as long cache line of data 70 to the requesting client. Cache memory 40 may aggregate short cache lines of data 72 as long cache line of data 70 and may return long cache line of data 70 to the requesting client.

Because cache memory 40 disaggregates long cache line of data 70 into short cache lines of data 72 that are stored in memory banks 58, cache memory 40 may be able to service requests to read or write individual short cache lines of data within short cache lines of data 72 that were created as a result of disaggregating long cache line of data 70. For example, cache memory 40 may be able to service a request from a client for a short cache line of data at a memory address associated with short cache line of data 72C by returning short cache line of data 72C stored in memory bank 58C to the requesting client. Similarly, cache memory 40 may be able to service a request to write a short cache line of data to a memory address associated with, for example, short cache line of data 72C to overwrite short cache line of data 72C in memory bank 58C with the data from the write request.

Cache memory 40 may be able to map the locations of short cache lines of data 72 in memory banks 58 based on the locations of tags 74 in tag banks 52. Busses (not shown) within cache memory 40 may carry tag_wid, tag_bid signals associated with each tag in tag banks 52, and data_wid, and data_bid signals associated with each short cache line of data stored in memory banks 58A. The tag_bid signal for a tag may be an indication of the specific memory bank (of memory banks 58) in which the tag is stored, while the tag_wid signal for a tag may be an indication of the location within a tag store (of tag stores 52) in which the tag is stored. Similarly, the data_bid signal for a short cache line of data may be an indication of the specific memory bank (of memory banks 58) in which the short cache line of data is stored, while the data_wid signal for a short cache line of data may be an indication of the location within a data store (of data stores 54) in which the short cache line of data is stored.

Cache memory 40 may generate data_bid and data_wid signals from tag_bid and tag_wid signals, in the example where four tags are associated with four short cache lines of data, as follows:

Data_bid=tag_wid[1:0]
Data_wid={tag_bid[1:0], tag_wid[3:2]}

In the case where four tags are associated with four short cache lines of data, each tag will be stored in a different location within a single tag bank. Thus, tag_wid[1:0] may differ for each tag. Thus, data_bid will be different for each short cache line of data associated with a tag, so that each short cache line of data is stored in a different memory bank of memory banks 58.

Further, because two bits are enough to indicate the locations of four tags within a single tag bank, tag_wid[3:2] will be the same for each of the four tags. In addition, because the four tags are stored in the same tag bank, tag_bid[1:0] will be the same for each of the four tags. Thus, the data_wid signal will be the same for each of the short cache lines of data, thereby indicating that each of the short cache lines of data are stored at the same location of each of memory banks 58. In this way, cache memory 40 may be able to generate, for a short cache line of data, an indication of the specific memory bank (of memory banks 58) in which the short cache line of data is stored, as well as an indication of the location within a data store (of data stores 54) in which the short cache line of data is stored, based at least in part on an indication of the specific memory bank (of memory banks 58) in which the tag associated with the short cache line of data is stored and an indication of the location within a tag store (of tag stores 52) in which the tag associated with the short cache line of data is stored

Cache memory 40 may also generate tag_bid and tag_wid signals from data_bid and data_wid signals, in the example where four tags are associated with four short cache lines of data, as follows:

Tag_bid=data_wid[3:2]
Tag_wid={data_wid[1:0], data_bid[1:0]}

In the case where four tags are associated with four short cache lines of data, two bits are enough to indicate the locations of four short cache lines of data. Therefore, data_wid[3:2] will be the same for each of the four short cache lines of data. Thus, the tag_bid signal will be the same for each of the four tags associated with four short cache lines of data, indicating that each of the four tags are stored in the same tag bank.

Further, because the four short cache lines of data are each stored in a different memory bank, tag_wid will be different for each of the four tags, thereby indicating that the four tags are stored in different locations within a single tag bank. In this way, cache memory 40 may be able to generate, for a short cache line of data, an indication of the specific memory bank (of memory banks 58) in which the tag associated with the short cache line of data is stored and an indication of the location within a tag store (of tag stores 52) in which the tag associated with the short cache line of data is stored, based at least in part on an indication of the specific memory bank (of memory banks 58) in which the short cache line of data is stored, as well as an indication of the location within a data store (of data stores 54) in which the short cache line of data is stored.

In other words, cache memory 40 may map the locations in memory banks 58 of tags associated with short cache lines of data to the locations in memory banks 58 of the associated short cache lines of data. Similarly, cache memory 40 may map the locations in memory banks 58 of short cache lines of data to the locations in memory banks 58 of tags associated with the short cache lines of data. Cache memory 40 may include logic blocks (e.g., hardware circuitry) that performs such mapping of tag locations to data locations, and data locations to tag locations. For example, memory banks 58 may include logic to perform mapping of tag locations to data locations, as well as logic to perform mapping of data locations to tag locations. Thus, cache memory 40 may be able to determine the location of data in data stores 54 based at least in part on the location of the tag associated with the data in tag stores 52. In addition, cache memory 40 may be able to determine the location of a tag in tag stores 52 based at least in part on the location of data associated with the tag in data stores 54.

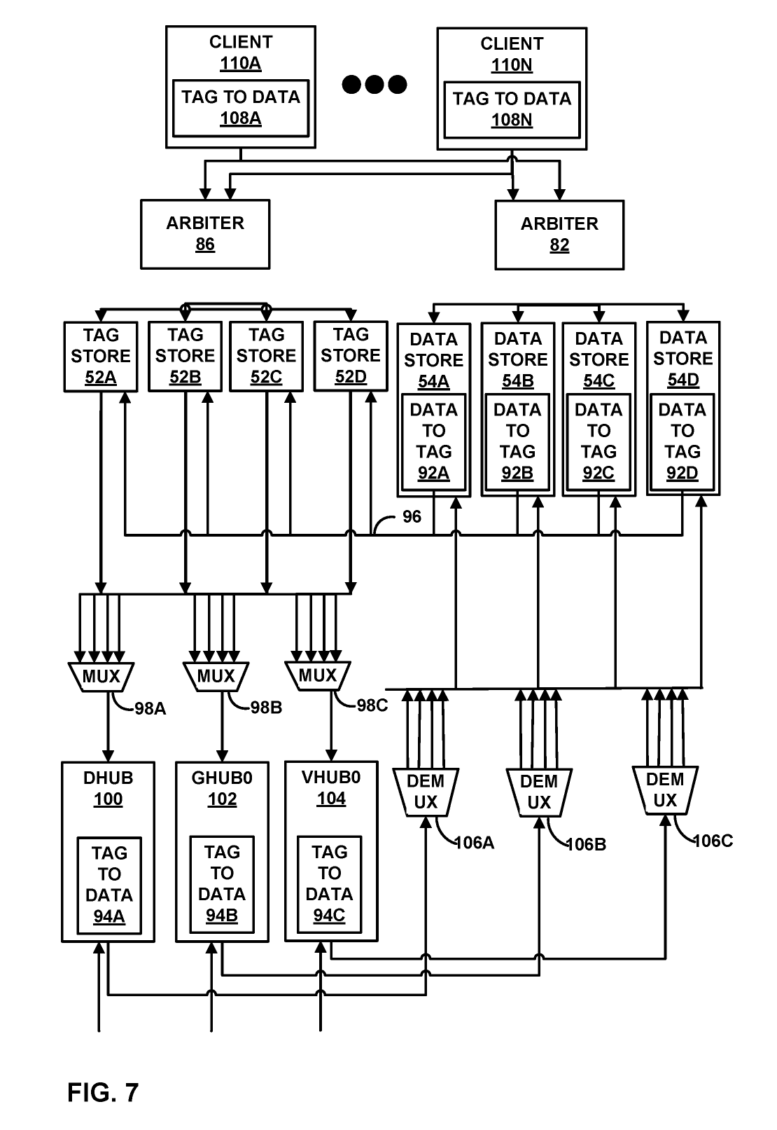

FIG. 7 is a block diagram illustrating the cache memory shown in FIGS. 4-6 in further detail. As shown, in FIG. 7, tag to data logic 108A-108N as well as tag to data logic 94A-94C may be hardware circuitry configured to generate data_bid and data_wid signals from tag_bid and tag_wid signals, as described above with respect to FIG. 6. Similarly, data to tag logic 92A-92D may be operably coupled to respective data stores 54A-54D and may be configured to generate tag_bid and tag_wid signals from data_bid and data_wid signals, as described above with respect to FIG. 6.

Clients 110A-110N may be examples of one or more clients 48 shown in FIG. 3, and may send requests to cache memory 40 to access data. Arbiter 86 may be configured to control access to tag stores 52. For example, arbiter 86 may determine which one of clients 110A-110N may access tag stores 52 at any one time to read or write tag data from tag stores 52. Similarly, arbiter 82 may determine which one of clients 110A-110N may access data stores 54 to read or write data from data stores 54.

Decompressor hub (DHUB) 100 may be configured to receive requested data from a decompressor. For example, if data is compressed in memory (e.g., memory 10), DHUB 100 may be configured to receive the compressed data, decompress the data, and to send the decompressed data to data stores 54. To that end, DHUB 100 may receive tag_bid and tag_wid signals from tag stores 52 and may utilize tag to data logic 94A to generate data_bid and data_wid signals, so that DHUB 100 may determine the locations in data stores 54 to which the received data should be stored.

Similarly, graphics memory hub (GHUB0) 102 may be configured to receive requested data from graphics memory 28, and to send the requested data to memory banks 58. To that end, GHUB0 102 may receive tag_bid and tag_wid signals from tag stores 52 and may utilize tag to data logic 94B to generate data_bid and data_wid signals, so that GHUB0 102 may determine the locations in data stores 54 to which the received data should be stored.

Similarly, memory bus hub (VHUB0) 104 may be configured to receive requested data from system memory 10, and to send the requested data to data stores 54. To that end, VHUB0 104 may receive tag_bid and tag_wid signals from tag stores 52 and may utilize tag to data logic 94C to generate data_bid and data_wid signals, so that VHUB0 104 may determine the locations in data stores 54 to which the received data should be stored.

Multiplexers 98A-98C may be associated with respective DHUB 100, GHUB0 102, and VHUB0 104 to multiplex data from tag stores 52 for respective DHUB 100, GHUB0 102, and VHUB0 104, so that multiplexers 98A-98C may each select from one of the four tag stores 52, so that tag data from one of the four tag stores 52 is sent to the respective DHUB 100, GHUB0 102, and VHUB0 104. Such tag data may include tag_bid and tag_wid signals for a plurality of tags for a plurality of short cache lines of data that make up a single long cache line of data.

DHUB 100, GHUB 102, and VHUB0 104 may each utilize tag to data logic 94B to generate data_bid and data_wid signals from the received tag_bid and tag_wid signals, and may send those generated data_bid and data_wid signals to demultiplexers 106A-106C. Demultiplexers 106A-106C may be configured to demultiplex the data_bid and data_wid signals to route access request for the plurality of short cache lines of data to the data store of the appropriate memory bank of memory banks 58.

When cache memory 40 receives a request for data from one of clients 110A-110N, cache memory 40 may perform tag checking and, in the case of a cache miss, allocate a plurality of short cache lines in data stores 54 across multiple memory banks of memory banks 58, as described throughout this disclosure. Cache memory 40 may also record the tag_bid and tag_wid signals in the requesting client (or clients 110A-110N) as well as in a decompression sidebus.

When the requested data is returned from memory, such as when the data is returned from a decompressor or if the client accesses a unified cache memory, cache memory 40 may utilize one or more of tag to data logic 94A-94C to generate data_bid and data_wid signals from tag_bid and tag_wid signals to determine the location of the plurality of short cache lines allocated in data stores 54 of memory banks 58 to store the retrieved data.

When cache memory 40 has finished accessing data stores 54 of memory banks 58, cache memory 40 may utilize data to tag logic 92A-92D to generate tag_bid and tag_wid signals from data_bid and data_wid signals to update corresponding flags in tag stores 52 for the data stored in data stores 54 of memory banks 58, such as via a data to tag crossbar 96. Data to tag logic 92A-92D may, in some examples, be operably coupled or situated in or near memory banks 58. In this way, tag stores 52 may work together with data stores 54 in memory banks 58 to load and store data.

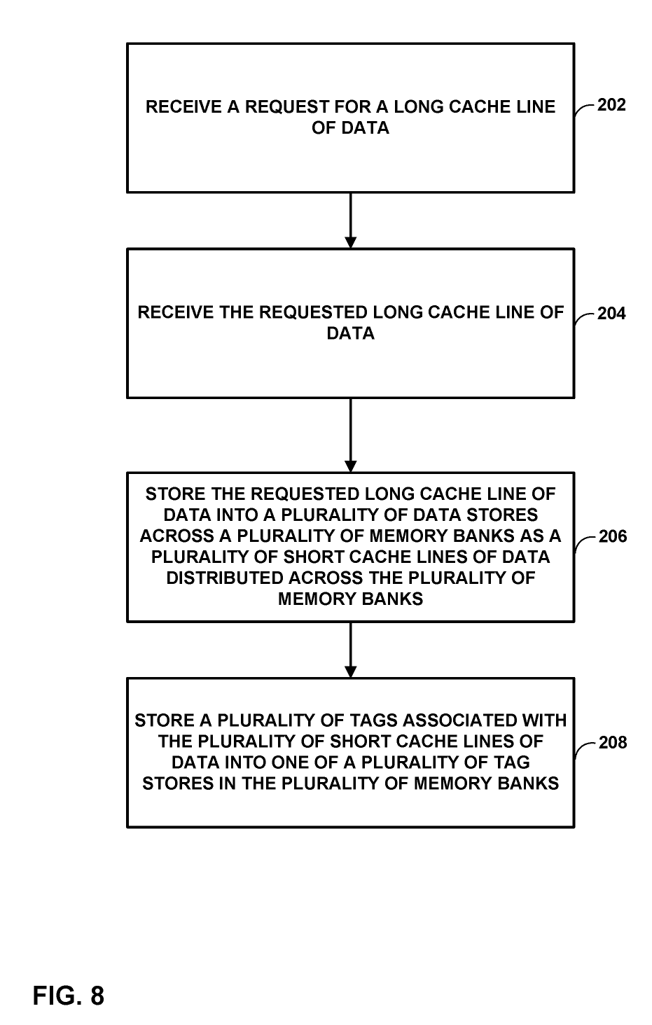

FIG. 8 is a flowchart illustrating an example process for utilizing a multi-bank cache memory to store and load both long cache lines of data as well as short cache lines of data. As shown in FIG. 8, the process may include receiving, by the cache memory 40 from a client, a request for a long cache line of data (202). The process may further include receiving, by the cache memory 40 from a memory 46, the requested long cache line of data (204). The process may further include storing, by the cache memory 40, the requested long cache line of data into a plurality of data stores 54 across a plurality of memory banks 58 as a plurality of short cache lines of data distributed across the plurality of data stores 54 in the cache memory 40 (206). The process may further include storing, by the cache memory 40, a plurality of tags associated with the plurality of short cache lines of data into one of a plurality of tag stores in the plurality of memory banks 58 (208).

In some examples, the long cache line of data has a data size that is larger than each of the plurality of short cache lines of data. In some examples, storing the requested long cache line of data into the plurality of data stores 54 may further include allocating a first short cache line in a first data store of the plurality of data stores 54, allocating a second short cache line in a second data store of the plurality of data stores 54, writing a first portion of the long cache line of data as a first short cache line of data of the plurality of short cache lines of data into the first short cache line, and writing a second portion of the long cache line of data as a second short cache line of data of the plurality of short cache lines of data into the second short cache line.

In some examples, wherein writing the first portion of the long cache line of data and writing the second portion of the long cache line of data may further include writing the first portion of the long cache line of data into the first data store and the second portion of the long cache line of data into the second data store at the same time. In some examples, the process may further include determining a first tag of the plurality of tags associated with the first short cache line based at least in part on a memory address of the long cache line of data, determining a second tag of the plurality of tags associated with the second short cache line based at least in part on a memory address of the long cache line of data, storing the first tag in a tag store of the plurality of tag stores 52, and storing the second tag in the tag store of the plurality of tag stores 52.

In some examples, the process may further include receiving, by the cache memory 40 from the client, a request for the first short cache line of data, and returning, by the cache memory 40 to the client, the first short cache line of data. In some examples, the process may further include receiving, by the cache memory 40 from the client, a request to write a short cache line of data, and writing the short cache line of data into the first short cache line. In some examples, the process may further include receiving, by the cache memory 40 from the client, a request for the long cache line of data, and returning, by the cache memory 40 to the client, the plurality of short cache lines of data as the long cache line of data.

In some examples, each one of the plurality of tags is associated with a different one of the plurality of short cache lines of data.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry such as discrete hardware that performs processing.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware, firmware, and/or software components, or integrated within common or separate hardware or software components.

The techniques described in this disclosure may also be stored, embodied or encoded in a computer-readable medium, such as a computer-readable storage medium that stores instructions. Instructions embedded or encoded in a computer-readable medium may cause one or more processors to perform the techniques described herein, e.g., when the instructions are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable storage media that is tangible.

Computer-readable media may include computer-readable storage media, which corresponds to a tangible storage medium, such as those listed above. Computer-readable media may also comprise communication media including any medium that facilitates transfer of a computer program from one place to another, e.g., according to a communication protocol. In this manner, the phrase “computer-readable media” generally may correspond to (1) tangible computer-readable storage media which is non-transitory, and (2) a non-tangible computer-readable communication medium such as a transitory signal or carrier wave.

Various aspects and examples have been described. However, modifications can be made to the structure or techniques of this disclosure without departing from the scope of the following claims.

What is claimed is:

1. A method comprising:
receiving, by a cache memory from a client, a request for a long cache line of data;
receiving, by the cache memory from a memory, the requested long cache line of data;
storing, by the cache memory, the requested long cache line of data into a plurality of data stores across a plurality of memory banks as a plurality of short cache lines of data distributed across the plurality of data stores in the cache memory; and
storing, by the cache memory, a plurality of tags associated with the plurality of short cache lines of data into one of a plurality of tag stores in the plurality of memory banks.

2. The method of claim 1, wherein storing the requested long cache line of data into the plurality of data stores comprises:
allocating, by the cache memory, a first short cache line in a first data store of the plurality of data stores;
allocating, by the cache memory, a second short cache line in a second data store of the plurality of data stores;
writing, by the cache memory, a first portion of the long cache line of data as a first short cache line of data of the plurality of short cache lines of data into the first short cache line; and
writing, by the cache memory, a second portion of the long cache line of data as a second short cache line of data of the plurality of short cache lines of data into the second short cache line.

3. The method of claim 2, wherein writing the first portion of the long cache line of data and writing the second portion of the long cache line of data further comprises:
writing, by the cache memory, the first portion of the long cache line of data into the first data store and the second portion of the long cache line of data into the second data store at the same time.

4. The method of claim 2, further comprising:
determining, by the cache memory, a first tag of the plurality of tags associated with the first short cache line based at least in part on a memory address of the long cache line of data;
determining, by the cache memory, a second tag of the plurality of tags associated with the second short cache line based at least in part on a memory address of the long cache line of data;
storing, by the cache memory, the first tag in a tag store of the plurality of tag stores; and
storing, by the cache memory, the second tag in the tag store of the plurality of tag stores.

5. The method of claim 2, further comprising:
receiving, by the cache memory from the client, a request for the first short cache line of data; and
returning, by the cache memory to the client, the first short cache line of data.

6. The method of claim 2, further comprising:
receiving, by the cache memory from the client, a request to write a short cache line of data; and
writing the short cache line of data into the first short cache line.

7. The method of claim 2, further comprising:
receiving, by the cache memory from the client, a request for the long cache line of data; and
returning, by the cache memory to the client, the plurality of short cache lines of data as the long cache line of data.

8. The method of claim 1, wherein each one of the plurality of tags is associated with a different one of the plurality of short cache lines of data.

9. The method of claim 1, further comprising:
determining, by the cache memory for a tag, a location of a short cache line of data associated with the tag in the plurality of data stores based at least in part on a location of the tag in the plurality of tag stores.

10. The method of claim 1, further comprising:
determining, by the cache memory for a short cache line of data stored in the plurality of data stores, a location of a tag associated with the short cache line of data in the plurality of tag stores based at least in part on a location of the short cache line of data in the plurality of data stores.

11. An apparatus comprising:
a memory;
a cache memory operably coupled to the memory and configured to:
receive, from a client, a request for a long cache line of data;
receive, from the memory, the requested long cache line of data;
store the requested long cache line of data into a plurality of data stores across a plurality of memory banks as a plurality of short cache lines of data distributed across the plurality of data stores in the cache memory; and
store a plurality of tags associated with the plurality of short cache lines of data into one of a plurality of tag stores in the plurality of memory banks.

12. The apparatus of claim 11, wherein the cache memory is further configured to:
allocate a first short cache line in a first data store of the plurality of data stores;
allocate a second short cache line in a second data store of the plurality of data stores;
write a first portion of the long cache line of data as a first short cache line of data of the plurality of short cache lines of data into the first short cache line; and
write a second portion of the long cache line of data as a second short cache line of data of the plurality of short cache lines of data into the second short cache line.

13. The apparatus of claim 12, wherein the cache memory is further configured to:
write the first portion of the long cache line of data into the first data store and the second portion of the long cache line of data into the second data store at the same time.

14. The apparatus of claim 12, wherein the cache memory is further configured to:
determine a first tag of the plurality of tags associated with the first short cache line based at least in part on a memory address of the long cache line of data;
determine a second tag of the plurality of tags associated with the second short cache line based at least in part on a memory address of the long cache line of data;
store the first tag in a tag store of the plurality of tag stores; and
store the second tag in the tag store of the plurality of tag stores.

15. The apparatus of claim 12, wherein the cache memory is further configured to:
receive, from the client, a request for the first short cache line of data; and
return, to the client, the first short cache line of data.

16. The apparatus of claim 12, wherein the cache memory is further configured to:
receive, from the client, a request to write a short cache line of data; and
write the short cache line of data into the first short cache line.

17. The apparatus of claim 12, wherein the cache memory is further configured to:
receive, from the client, a request for the long cache line of data; and
return, to the client, the plurality of short cache lines of data as the long cache line of data.

18. An apparatus comprising:
means for receiving, from a client, a request for a long cache line of data;
means for receiving, from a memory, the requested long cache line of data;
means for storing the requested long cache line of data into a plurality of data stores across a plurality of memory banks in cache memory as a plurality of short cache lines of data distributed across the plurality of data stores in the cache memory; and
means for storing a plurality of tags associated with the plurality of short cache lines of data into one of a plurality of tag stores in the plurality of memory banks in the cache memory.

19. The apparatus of claim 18, wherein the means for storing the requested long cache line of data into the plurality of data stores further comprises:
means for allocating a first short cache line in a first data store of the plurality of data stores;
means for allocating a second short cache line in a second data store of the plurality of data stores;
means for writing a first portion of the long cache line of data as a first short cache line of data of the plurality of short cache lines of data into the first short cache line; and
means for writing a second portion of the long cache line of data as a second short cache line of data of the plurality of short cache lines of data into the second short cache line.

20. The apparatus of claim 19, wherein the means for writing the first portion of the long cache line of data and writing the second portion of the long cache line of data further comprises:
means for writing the first portion of the long cache line of data into the first data store and the second portion of the long cache line of data into the second data store at the same time.

21. The apparatus of claim 19, further comprising:
means for determining a first tag of the plurality of tags associated with the first short cache line based at least in part on a memory address of the long cache line of data;
means for determining a second tag of the plurality of tags associated with the second short cache line based at least in part on a memory address of the long cache line of data;
means for storing the first tag in a tag store of the plurality of tag stores; and
means for storing the second tag in the tag store of the plurality of tag stores.

22. The apparatus of claim 19, further comprising:
means for receiving, from the client, a request for the first short cache line of data; and
means for returning, to the client, the first short cache line of data.

23. The apparatus of claim 19, further comprising:
means for receiving, from the client, a request to write a short cache line of data; and
means for writing the short cache line of data into the first short cache line.

24. The apparatus of claim 19, further comprising:
means for receiving, from the client, a request for the long cache line of data; and
means for returning, to the client, the plurality of short cache lines of data as the long cache line of data.

25. A non-transitory computer readable storage medium storing instructions that upon execution by one or more processors cause the one or more processors to:
receive, from a client, a request for a long cache line of data;
receive, from the memory, the requested long cache line of data;
store the requested long cache line of data into a plurality of data stores across a plurality of memory banks in cache memory as a plurality of short cache lines of data distributed across the plurality of data stores in the cache memory; and
store a plurality of tags associated with the plurality of short cache lines of data into one of a plurality of tag stores in the plurality of memory banks in the cache memory.

26. The non-transitory computer readable storage medium of claim 25, wherein the instructions, upon execution, by the one or more processors, further cause the one or more processors to:
allocate a first short cache line in a first data store of the plurality of data stores;
allocate a second short cache line in a second data store of the plurality of data stores;
write a first portion of the long cache line of data as a first short cache line of data of the plurality of short cache lines of data into the first short cache line; and
write a second portion of the long cache line of data as a second short cache line of data of the plurality of short cache lines of data into the second short cache line.

27. The non-transitory computer readable storage medium of claim 26, wherein the instructions, upon execution, by the one or more processors, further cause the one or more processors to:
determine a first tag of the plurality of tags associated with the first short cache line based at least in part on a memory address of the long cache line of data;
determine a second tag of the plurality of tags associated with the second short cache line based at least in part on a memory address of the long cache line of data;
store the first tag in a tag store of the plurality of tag stores; and
store the second tag in the tag store of the plurality of tag stores.

28. The non-transitory computer readable storage medium of claim 26, wherein the instructions, upon execution, by the one or more processors, further cause the one or more processors to:
receive, from the client, a request for the first short cache line of data; and
return, to the client, the first short cache line of data.

29. The non-transitory computer readable storage medium of claim 26, wherein the instructions, upon execution, by the one or more processors, further cause the one or more processors to:
receive, from the client, a request to write a short cache line of data; and
write the short cache line of data into the first short cache line.

30. The non-transitory computer readable storage medium of claim 26, wherein the instructions, upon execution, by the one or more processors, further cause the one or more processors to:
receive, from the client, a request for the long cache line of data; and
return, to the client, the plurality of short cache lines of data as the long cache line of data.
